(19) United States
(12) Patent Application Publication
(10) Pub. No.: US 2004/0189647 A1
(43) Pub. Date: Sep. 30, 2004

(54) Interactive behavioral authoring of deterministic animation

(76) Inventors: Michael C. Sheasby, Boucherville (CA); Yoshihito Y. Koga, Mountain View, CA (US)

Correspondence Address: PETER J. GORDON, PATENT COUNSEL, AVID TECHNOLOGY, INC., ONE PARK WEST, TEWKSBURY, MA, 01876, US

(21) Appl. No.: 10/818,675

(22) Filed: Apr. 6, 2004

Related U.S. Application Data
(63) Continuation of application No. 09/909,609, filed on Jul. 20, 2001.
(60) Provisional application No. 60/219,978, filed on Jul. 21, 2000.

(51) Int. Cl. G06T 15/70

(52) U.S. Cl. 345/473

(57) ABSTRACT

A computerized editing system for 3 dimensional animation is provided that includes 3 dimensional characters, which expose behaviors. The 3 dimensional characters invoke their behaviors in response to trigger events, and the animation scene can be configured with the trigger events on a timeline. After designing the animation scene and refining it, the animator can cause the system to generate animation data that is representative of deterministic animation.

### CROSS REFERENCE TO RELATED APPLICATIONS

This application claims the benefit under 35 U.S.C. §120, and is a continuation application of:

1. Application Ser. No. 09/909,609, filed on Jul. 20, 2001, pending, which is a nonprovisional application of provisional application Ser. No. 60/219,978, filed on Jul. 21, 2000.

This application also claims the benefit under 35 U.S.C. §119 of:

2. Provisional application Ser. No. 60/219,978, filed on Jul. 21, 2000;

both of which are incorporated herein by reference.

### FIELD OF THE INVENTION

This invention relates generally to the authoring of deterministic animation, and more particularly to the authoring of deterministic animation using characters that expose a behavior and skill set.

### BACKGROUND OF THE INVENTION

The making of a 3D animation has evolved to ever-higher levels of sophistication. The field has progressed from animation of direct parameters such as scale/rotation/position, through inverse kinematics which implicitly calculate position parameters to satisfy the user's intention of a character's movement, through non-linear animation, which allows users to deal with blocks of animation instead of unmanageable lists of function curves. The next logical step in this progression is imbuing animated objects with the ability to respond to events from the user or the environment.

By giving characters even modest ‘intelligence’, animation can be created more fluidly. Animators can concentrate on pacing and the storytelling of a scene, without losing any control over the fine mechanics of how characters move. Artists can work with characters like a director working with an actor on the stage, for example instructing a character to go to a particular location and pick up a specified object. A primary challenge in dealing with behavioral animation is that it is simulated, and thus operates in an interactive mode as opposed to the traditional timeline-based metaphor of traditional animation. Like a video game, a behavioral simulation only goes forward in time and can continue to simulate as long as the user wishes to keep interacting with it. In contrast, playback of animated motion on a traditional animation system only occurs when the timeline playback position is moving in time. What is needed is a system, which integrates behavioral simulation with the fixed, finite, deterministic timeline that is more familiar to today's animators. Systems exist which allow the user to ‘demonstrate’ animation, such as motion capture systems. Other systems exist which allow the user to trigger animations from a bank of known animations and record the results. These systems have the drawback that once animation has been recorded it can only be edited by working directly with function curve data (which map the positions of joints against time). What is desired is a system that records the events fed to the simulation, and not necessarily the actual motion which results. This enables the user to modify the time or content of the events fired into the simulation as well as the arrangement of the scene, and rerun it in order to receive modified results. This tightens the loop in which the animator iterates over a scene to produce the most artistically pleasing result.

### SUMMARY OF THE INVENTION

The present invention is directed to a computerized system for editing a three-dimensional (3D) animation, which receives 3D characters, trigger events, and generates the animation of the 3D characters in response to receiving the trigger events.

In one aspect of the invention, 3D characters have behaviors and associated skills, and the trigger events cause at least one 3D character in the animation to invoke a behavior.

In another aspect of the invention, trigger events are visually displayed on a timeline, and can be manipulated to change the timing of the action within the animation. The allocation of trigger events to tracks on the timeline is flexible; for example, one or more timeline tracks can be associated with a 3D character,an animated scene may have a single timeline in which trigger events are placed for all the 3D characters in the scene.

In a yet further aspect of the invention, the animation may be refined through manipulation of the trigger events on the timeline as well as the arrangement of the scene, and when the animation is configured as desired it can be “baked” to produce animation data representative of a deterministic animation. Baking refers to the selective recording of the motion to keyframe animation or other animation data. The animator may choose the 3D parameters that are to be recorded. The bake process may be an independent step in the invention, or may be included transparently to the animator in another step.

In another aspect of the invention, trigger events are generated for invoking at least one behavior and skill of one of the 3D characters in response to interactively receiving instructions to configure a 3D animated scene.

### BRIEF DESCRIPTION OF THE DRAWINGS

FIG. 1 is a schematic diagram of a computerized editing system according to the present invention.

FIG. 2 is block diagram of the steps for practicing the present invention.

FIG. 3 is depiction of a graphical user interface (GUI) according to the invention.

FIG. 4 is a timeline and associated trigger events.

FIG. 5 shows a data structure for a representative trigger event.

FIG. 6 depicts a timeline according to the invention with two trigger events.

FIG. 7 is a block diagram of the steps involved in the bake step.

### DETAILED DESCRIPTION

The present invention is directed to an authoring tool on a computer system for generating deterministic animation that is responsive to the behaviors and skill sets of characters in a three-dimensional animation setting. It being understood that characters are not restricted to only animated people or animals, but may also include other objects such as light sources, telephones, an environment or cameras.

A skill describes how a character accomplishes a specific act. Examples include walking, sitting, or grasping an object. Skills can be created using Inverse Kinematics (IK) or Forward Kinematics, dynamics, motion capture, neural nets, or other apparatus. It is important to note that skills are not necessarily keyframed animation. Any computation that produces the desired result of the skill is acceptable; for example, a dynamics simulation might be used. A defined skill may be used in conjunction with another skill to generate a complex skill. For example, the skill of walking may be used in conjunction with the skill of waving an arm to form the walking-while-waving skill.

A behavior describes the ability of a character or environment to react to a complex command, such as “walk from here to there” or “pick up that glass” and may also be a response to an event such as a character entering a room in the scene. An example of an environmental behavior is the light in a scene is dimmed when the “thunder event” occurs. The character uses a library of skills, combined with logic, to achieve the desired behavior. The logic can be expressed as any combination of Finite State Machines (FSM), scripting, or compiled computer code. A character with behavioral intelligence exposes a set of behaviors that can be seen by the outside world. For example, a character may exhibit the behavior of opening the door in response to a ringing of a doorbell. The behavior is accomplished through the application of one or more skills such as walking and extending an arm to grasp a doorknob.

Typically behavioral animation is used to interactively produce content in response to live user input, driving the current state of characters that possess a set of behaviors. User input drives the current state of characters that possess particular behaviors. However, the present invention rather than generate only interactive content merges behavioral animation techniques and linear animation tools to generate deterministic linear animation.

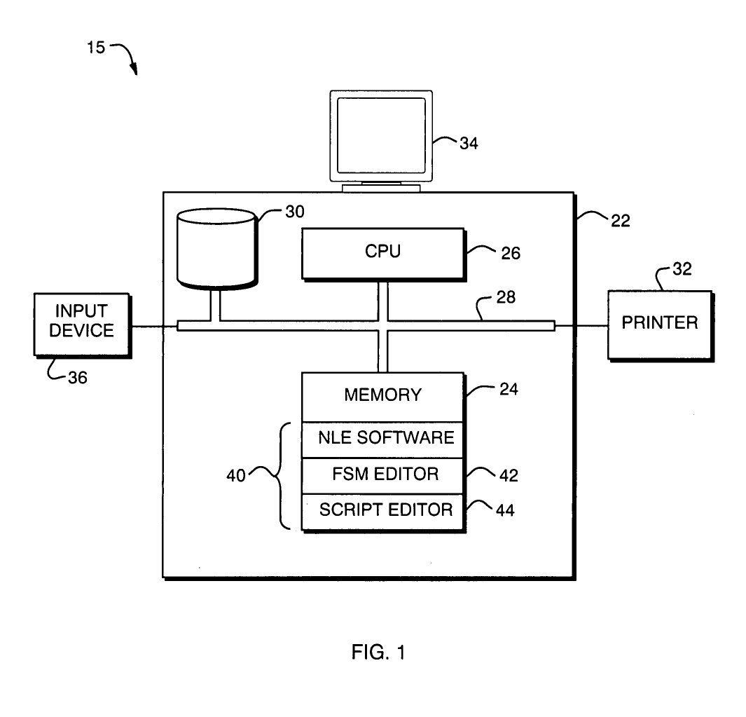

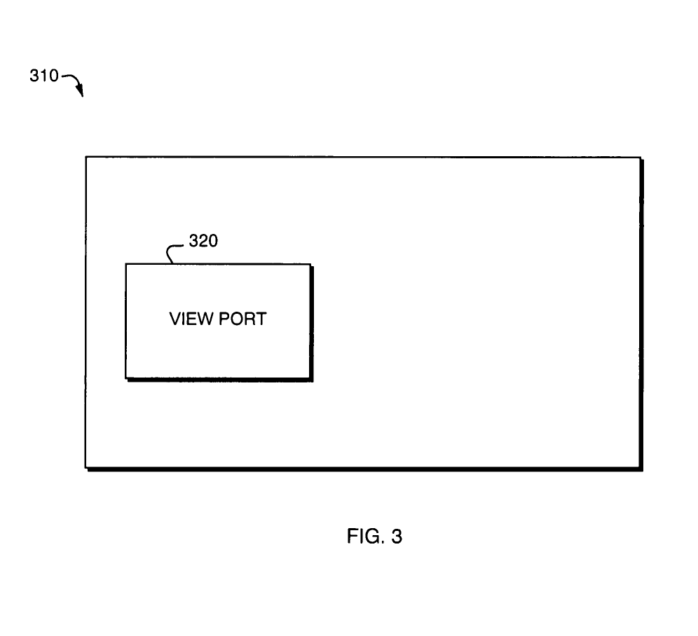

The present invention may be implemented on a computerized editing system 15 such as shown in FIG. 1. Such a system 15 commonly includes a computer 22 with a volatile, typically random-access, memory 24 connected to a central processing unit (CPU) 26 via a bus 28. Conventional computer systems, as well as those specially designed for video editing, may be used as the system 15 for the purpose of editing. More conventional computer systems may also include a printer 32 and non-volatile memory or storage 30, such as a hard disk or optical disk. The computer system 15 may be connected to a communications network (not shown) for receiving animated content from other computer systems. The computer system 15 may also include a video display 34 an input device 36 such as a mouse, keyboard, joystick or other pointing device. Computer system 15 includes Non-linear Editing (NLE) software 40 that is stored in the memory 24 and executed on CPU 26 to perform the details of the invention. As is generally depicted in FIG. 3, NLE software 40 presents on display 34 a graphical user interface (GUI) 310 for receiving information from the animator and displaying output information. The concept of a GUI is well known to those of ordinary skill in the art of computerized editing systems. GUI 310 includes a view port 320 for displaying the played animation. GUI 310 includes the capability of receiving commands from the animator for defining the behaviors and skill associated with a particular character or environment. As previously discussed, behaviors and skills are typically programmed or scripted in advance using a separate application or within the NLE software 40 and stored in a library on the non-volatile storage 30 for later use by the NLE software 40. An animator may select the behaviors and skills associated with the characters from that library. Alternatively, using NLE software 40 the animator may combine skills as previously described in order to create a more complex skill and store the resulting skill in the library. The skill set of the NLE software 40 is thus easily expanded by the animator to address particular animation applications.

A computerized editing system 15 suitable for the present invention is described in a U.S. patent application Ser. No. 09/049,066 and entitled “Method and System for Editing or Modifying 3D Animations in a Non-linear Editing Environment which is assigned to Avid Technology, Inc., the assignee of this invention, and is expressly incorporated by reference herein.

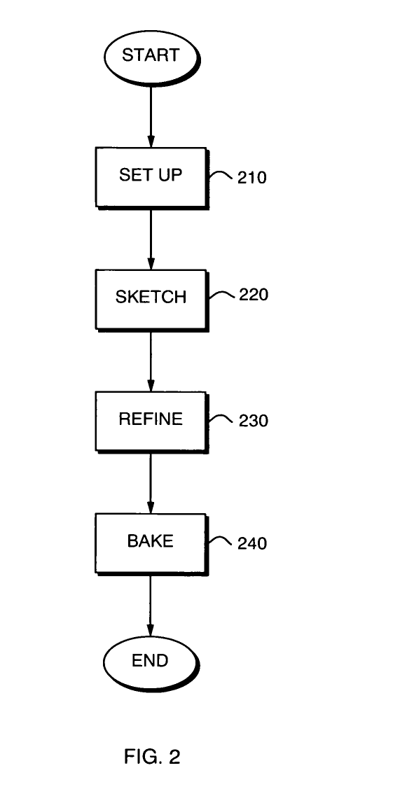

As is shown in FIG. 2, a user of a system according to the present invention initially creates in step 210 the behaviors and skill sets for the characters involved in the animation, and prepares the scene for behavioral animation. In step 220, the user interactively sketches the animation using behavioral animation techniques as described in more detail later to generate the desired animation. Steps 210 and 220 can be refined repeatably as shown in step 230 until the animator is satisfied with the result and then as shown in step 240 can “bake” the behavior animation so as to produce a deterministic animation. “Baking” data refers to the process of converting animated data to a linear list of keyframes, mapping parameter values versus time.

The Set Up Step

In step 210 of FIG. 2, an animator assembles the elements required for the animation scene using behavioral animation techniques as described in U.S. Pat. No. 6,208,357, entitled “METHOD AND APPARATUS FOR CREATING AND ANIMATING CHARACTERS HAVING ASSOCIATED BEHAVIOR” which is assigned to the same assignee as this application and is incorporated by reference herein. An animator may use a set of pre-packaged components or may build his own components based on the techniques outlined in U.S. Pat. No. 6,208,357 for setting up the scene for behavioral animation. The pre-packaged components may consist of modules that range from facilitating the arrangement of the characters in the scene to endowing them with specific behaviors. In addition to their construction, the components will be glued together using the techniques outlined in U.S. Pat. No. 6,208,357.

An example of using a pre-packaged component for setting up the scene is a module that places a cluster of characters around the click point of a point and click device. By specifying the character to place and the density and number of characters to place around the click point, an animator can populate their scene according to the specifications of the sequence. Furthermore, one could add an additional component that isprocessed after the characters have been placed to have them face a specific direction.

Once the scene is populated, further behaviors may be associated with the characters in the scene to set them up for the sketch step. Some of these behaviors may be made up of pre-packaged components that handle tasks such as turning in place and walking to points specified by a click event coming from a point and click device. The prepackaged behaviors can become extremely complex, for example simulating the control and flight of a fighter jet. In this case, events feeding into this component may be produced by joystick and an array of controls inside a version of the cockpit. Behaviors can also respond to events, for example a character can expose a behavior causing it to blink when a specific keyboard key is pressed.

Each behavioral component will publish their interface to initiate their action. The interface may include required or optional parameters and dependencies. These are interfaces that are registered with the system, and can be referenced by an event in the timeline of this system. Components will also come with parameters for their usage. For example, a component that populates the scene with a cluster of characters may expose as parameters the name of the character to place, the number, and the density of the cluster. Furthermore, a component may publish any dependencies it has on it execution. For example, a component may use a beacon in the scene as a target for driving the motion of its associated character. By moving the beacon, the resulting motion of the character can be modified.

To manage the large number of prepackaged and custom components that are available for use in the system, a database may be used to facilitate their identification. When components are added to the database, identifying keywords are associated with it. A user-friendly interface assists in locating components and then adding and gluing them into behaviors of a character.

The Sketch Step

Having defined the assets and resources required in the Set Up step, the Sketch step according to the invention will now be described.

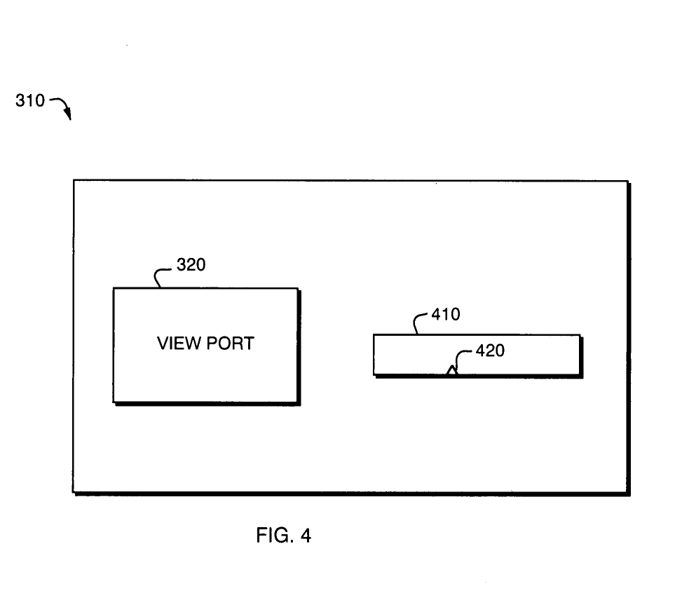

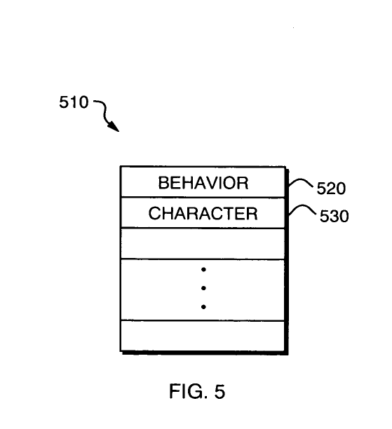

GUI 310 includes a timeline 410 as shown in FIG. 4 for specifying versus time triggering events 420 to the NLE software 40. Each triggering event 420 is sent to a behavior, which may in turn result in the application of the associated skills of that character. The animator may select the triggering event to be placed on timeline 410 from a library of such triggering events 420. A triggering event 420 may be moved along timeline 410 in order to change the time at which the triggering event occurs. As shown in FIG. 5, triggering event 420 includes a data structure 510 in NLE software 40 that at least includes a reference 520 to the behavior to receive the event. Timeline 410 is sized in convenient units of time to display the full duration of the animated scene that is being worked on. NLE software 40 includes a “expand” capability to enlarge a selected portion of the timeline 410 for a more precise placing of the triggering event 420 in timeline 410. A portion of the timeline 410 may be selected for enlargement using a point and click device such as a mouse to define the start and end points of the selected portion. Alternatively, GUI 310 allows for the input of the start and end times using a keyboard. NLE software also includes a “compress” capability to compress the timeline 410 to its original size. The timeline 410 may be associated with the entire animated scene or may alternatively be only associated with one character, each character in the scene having one or more timelines 410 associated therewith. If the timeline 410 corresponds to the entire scene then the data structure 510 of trigger event 420 also identifies the character 530 for which the trigger event applies. In order to enhance identification of a character's trigger events 420, the events may be color coded according to a particular character. The representation of events may also be coded by user preference, according to the type of event being fired, or other criteria.

In another embodiment of the invention, a triggering event 420 is placed on the timeline 410 by invoking the triggering event 420 while the simulation is active. In this embodiment, the trigger events 420 are placed on the timeline 410 by running the simulation and specifying trigger events during simulation with an input device 36. This is of course different than setting up all the trigger events 420 on the timeline 410 prior to initiating playback. As an example, it is desired in a scene for a dinosaur to walk to a specified location then blink. In order to accomplish this action, the animator prepares the scene, goes to ‘record’ mode, and clicks using a point and click device at the destination location. Consequently, the dinosaur turns and walks over to that point. The animator presses a key bound to the “blink” behavior and the dinosaur blinks.

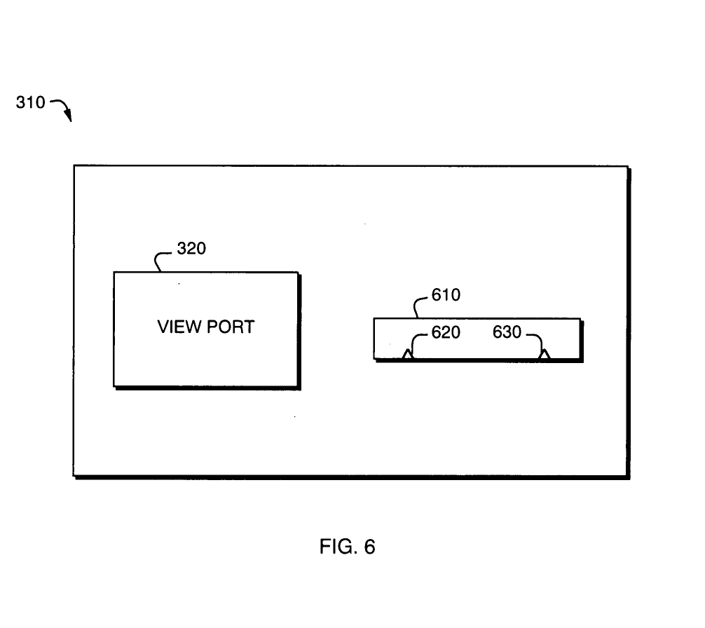

As shown in FIG. 6, the animator now has a timeline 610 with two triggering events.

The first triggering event 620 invokes a “walk to” behavior. Triggering event 620 includes a parameter specifying the location that the character should walk to. It may also include attributes, such as the style with which the character should walk (run, walk, limp). The second triggering event 430 invokes a blink behavior, which may or may not have additional parameters such as blink speed.

During playback, when the triggering events 620 and 630 are encountered, an event is sent to one of many behaviors, for example finite state machines controlling the dinosaur in question. Inverse Kinetics (IK) solving, motion blending, and regular animation may be blended together by the “run-time engine” to produce the interactive content desired.

The Refine Step

In the refine step, the animator tunes the animation that was roughly constructed in the sketch step. This step may include changing the frame or time at which a given trigger generates an event or changing the parameters and dependencies exposed by the behaviors, such as, in the last example, the position that the dinosaur walks to. Behaviors may publish parameters that were not set during the interactive phase, such as timing for the speed at which the dinosaur walks from point to point. The animator may also add and remove trigger events. New events may also include “back-timed” keys, which indicate a frame by which a certain action should already be accomplished. For example, the animator may pick a frame and say “at this frame, the dinosaur should be looking over its left shoulder”. The animator may also configure behaviors to use inputs derived from other data available in the system, such as distance to other objects or internal parameters such as the phase of a current walk cycle. The animator may also tweak the duration of transitions, such as going from a standing position to walking, and from walking to stopping. This may be done through the GUI. The sketch step dealt with recording interactive events. In the refine step, the contents of the timeline 410 can be modified at the artist's leisure to alter the time or parameters for a triggering event 420. The animator and director work to get the animation into a form where the director is satisfied with the rough timing and positions of the objects in the scene. It is still interactive; the form of the animation can be changed by moving characters, changing animation parameters, editing dependencies or changing event times.

The user can add new events to the timeline in one of two ways: by overlaying new events generated during an interactive ‘performance’ session, or by manually adding events to the timeline itself. The user can iteratively loop through the sketched animation and layer new events into the timeline. For example, the user can play over the timeline holding the two events described above (which send the dinosaur to a specific location and make it blink) and trigger a new event, which causes the dinosaur to roar. This event is recorded along side the existing events in the timeline and affects the resulting simulation.

Alternatively the user can stop the simulation, select a specific time within the timeline, and add an event to a selected track by one of a variety of methods (such as selecting the event from a list, choosing from a contextual menu, or pressing a keyboard shortcut). In one embodiment of the invention, the animator also has access to a set of Finite State Machines (FSMs) that drive the behaviors referenced by the triggering events 420. NLE software 40 may include FSM editor 42 which may have a graphical and/or script based interface. The animator can open the FSM editor 42 to view the current state of the character, or open a script editor 44 that is also included in NLE software 40 to see the line currently being executed. The animator can scrub back and forth over the timeline and see the dinosaur move as if the animation had been produced by hand using more traditional keyframing methods. Note that new keys can be added either interactively during playback or adding them onto the timeline 410.

NLE software 40 caches the status of the simulation that drives the behaviors during playback as specified by the animator. The animator may choose that a cache be generated at each trigger event 420 or at periodic time intervals. Caching the status of the simulation allows the animator to scrub back in time over the timeline 410 and restart the animation from an intermediate point on the timeline while changing the set of trigger points 420 in the timeline 410. When trigger events 420 are edited the cache data is updated accordingly.

The Bake Step

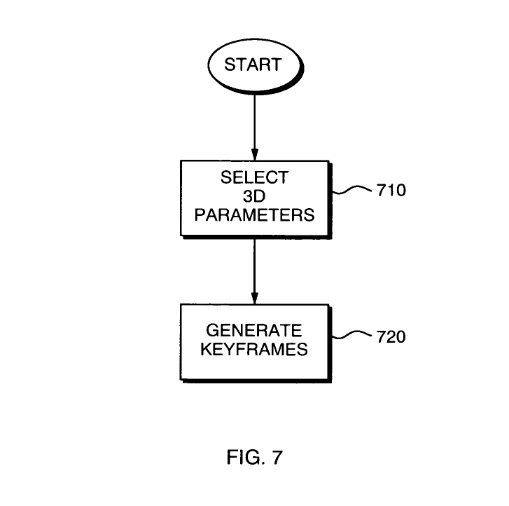

When the animator and director are satisfied with the rough blocking of the scene, the animator “bakes” the animation down to keyframed animation data. For purposes of explanation, the bake step is described as a separate step. However, one of ordinary skill in the art will recognize that the bake process could be folded into an earlier step and be performed transparent to the animator. It is for this reason that in FIG. 2 that steps 220 and 230 may circumvent an explicit bake step and go to completion of the process. If it has not already been accomplished during an earlier phase, the bake step converts the interactive content to deterministic content, producing animation curves such as the animator would have produced manually to create the same animation had he started from scratch. Reasons to delay the computation of these animation curves to this phase include reducing the performance overhead of managing animation for large crowds of simulated characters. As shown in FIG. 7 the animator, using the GUI 310 of the invention, may specify the parameters that are to be recorded during the bake step, step 710 and the NLE software 40 generates the keyframe animation data or other animation data as the animator has selected, step 720. The animator is then free to manipulate the resulting animation data using all the traditional tools available to him from the 3D package.

Contrary to conventional NLE editing systems, the NLE editing system according to the present invention creates time driven events that drive a logic engine. The interactive content created in the first three steps is not lost since changes the user makes to the baked data do not affect the initial work.

Having now described a few embodiments, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

We claim:

1. A computerized system for editing a three-dimensional (3D) animation, said system comprising:
a means for receiving 3D characters;
a means for receiving time driven trigger events;
a means for recording said time driven trigger events;
a simulation means for generating said animation of said 3D characters in response to said means for receiving time driven trigger events.

2. The computerized system of claim 1 wherein said means for receiving time driven trigger events includes a means for placing said trigger events into a timeline.

3. The computerized system of claim 1 wherein said 3D characters include behaviors and skills responsive to said behaviors, said behaviors being responsive to said trigger events.

4. The computerized system of claim 1 further including:
a bake means for selectively producing animation data to generate deterministic animation.

5. The computerized system of claim 1 wherein said means for receiving time driven trigger events includes a means for caching said trigger events and the status of said simulation means.

6. The computerized system of claim 1 wherein said simulation means includes a finite state machine (FSM) for driving said behaviors in response to said trigger events.

7. The computerized system of claim 4 wherein said animation data includes keyframe data.

8. A method for producing animation data representative of a deterministic animation constructed from three-dimensional (3D) characters; said method consisting of the steps of:
receiving said 3D characters, said 3D characters having behaviors;
generating trigger events for invoking at least one behavior of one of said 3D characters in response to interactively receiving instructions to configure a 3D scene;
baking said 3D animation to provide said animation data.

9. The method of claim 8 wherein said baking step includes producing keyframe animation.

10. The method of claim 8 wherein said generating step includes placing said trigger events on a timeline.

11. The method of claim 11 wherein said trigger events are time driven.

12. The method of claim 10 wherein placing said trigger events on a timeline includes a visual indicator representative said trigger events to identify one of said 3D characters.

13. The method of claim 12 wherein said visual indicator is color-coded.
